(19) United States
(12) Patent Application Publication
(10) Pub. No.: US 2003/0065860 A1
(43) Pub. Date: Apr. 3, 2003

(54) Internal control bus in a multiple processor/multiple bus system

(76) Inventors: Robert A. Lester, Tomball, TX (US); Kenneth T. Chin, Cypress, TX (US); Jim Blocker, Cypress, TX (US); John E. Larson, Houston, TX (US); Phillip M. Jones, Spring, TX (US); Paul B. Rawlins, Spring, TX (US)

Correspondence Address: Michael G. Fletcher, Fletcher, Yoder & Van Someren, P.O. Box 692289, Houston, TX, 77269-2289, US

(21) Appl. No.: 09/966,889

(22) Filed: Sep. 28, 2001

(51) Int. Cl. G06F 13/38

(52) U.S. Cl. 710/305

(57) ABSTRACT

An internal bus structure for a multi-processor-bus system. More specifically, an internal bus protocol/structure is described. The internal bus structure includes unidirectional, point-to-point connections between control modules. The individual buses carry unique transactions corresponding to a request. Each transaction includes an identification tag. The present protocol provides for efficient communication between processors, peripheral devices, memory and coherency modules. The present protocol and design scheme is generic in that the techniques are scalable and re-usable.

### BACKGROUND OF THE INVENTION

1. Field of the Invention

This invention relates generally to a multiple processor/multiple bus system and, more particularly, to an internal control bus configuration in the host controller of a multiple processor/multiple bus system.

2. Description of the Related Art

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Computer usage has increased dramatically over the past few decades. In past years, computers were relatively few in number and primarily used as scientific tools. However, with the advent of standardized architectures and operating systems, computers have become virtually indispensable for a wide variety of uses from business applications to home computing. Whether a computer system is a personal computer or a network of computers connected via a server interface, computers today rely on processors, associated chip sets, and memory chips to perform most of the processing functions, including the processing of system requests. The more complex the system architecture, the more difficult it becomes to efficiently process requests in the system.

Some systems, for example, include multiple processing units or microprocessors connected via a processor bus. To coordinate the exchange of information among the processors, a host controller is generally provided. The host controller is further tasked with coordinating the exchange of information between the plurality of processors and the system memory. The host controller may be responsible not only for the exchange of information in the typical Read-Only Memory (ROM) and the Random Access Memory (RAM), but also the cache memory in high speed systems. Cache memory is a special high speed storage mechanism which may be provided as a reserved section of the main memory or as an independent high-speed storage device. Essentially, the cache memory is a portion of the RAM which is made of high speed static RAM (SRAM) rather than the slower and cheaper dynamic RAM (DRAM) which may be used for the remainder of the main memory. By storing frequently accessed data and instructions in the SRAM, the system can minimize its access to the slower DRAM and thereby increase the request processing speed in the system.

The host controller may be responsible for coordinating the exchange of information among several buses as well. For example, the host controller may be responsible for coordinating the exchange of information from input/output (I/O) devices via an I/O bus. Further, more and more systems implement split processor buses, which means that the host controller is tasked with exchanging information between the I/O bus and a plurality of processor buses. With increased processor and memory speeds becoming more essential in today's fast-paced computing environment, it is advantageous to facilitate the exchange of information in the host controller as quickly as possible. Due to the complexities of the ever expanding system architectures which are being introduced in today's computer systems, the task of coordinating the exchange of information becomes increasingly difficult. Because of the increased complexity in the design of the host controller due to the increased complexity of the system architecture, more cycle latency is injected into the cycle time for processing system requests among the I/O devices, processing units, and memory devices which make up the system. Disadvantageously, increased cycle latency generally leads to slower request processing.

To coordinate activity within the host controller, various control modules, such as processor control modules, a memory control module, and a coherency control module, for example, may be provided. Previously, interfaces between the various modules in the host controller were created on a system-by-system basis. This lead to new proprietary implementations and protocols for each and every system design. Further, it greatly reduced the chance for design re-use. By providing non-standard internal bus protocol, a great deal of time and effort may be spent on design, re-design, and the training of technically qualified personnel to design, debug, and operate such systems.

As computer architecture designs continue to increase in size and complexity, and as design schedules continue to get shorter, design, debug, verification, and design re-use become increasingly critical. Further, despite the increase in complexity of the systems, processing speeds and system performance are constantly being optimized to provide better performance in less time. The internal bus protocol in the host controller of a complex computer system generally provides an interface between multiple I/O devices, system memory, and coherency control modules. The design of the internal bus is generally more complex as system performance and capabilities increase. An internal control bus is often required to facilitate and coordinate the exchange of requests and information in systems designed with multiple processors and multiple buses. The protocol for such a complex internal bus should allow for efficient communication between processors, I/O devices, memory, and coherency modules in such a way as to allow optimal system speeds and to provide for scalability as the number of processors or I/O devices in the system increases. Further, verification testing, debugging, and design re-use should also be considered is designing an internal bus and protocol structure.

The present invention may be directed to one or more of the problems as set forth above.

### BRIEF DESCRIPTION OF THE DRAWINGS

The foregoing and other advantages of the invention will become apparent upon reading the following detailed description and upon reference to the drawings in which:

FIG. 1 is a block diagram of an exemplary computer system having a multi-processor-bus architecture;

FIG. 2 is a block diagram of the host controller illustrated in FIG. 1; and

FIG. 3 is one embodiment of the internal bus described with reference to FIG. 2.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

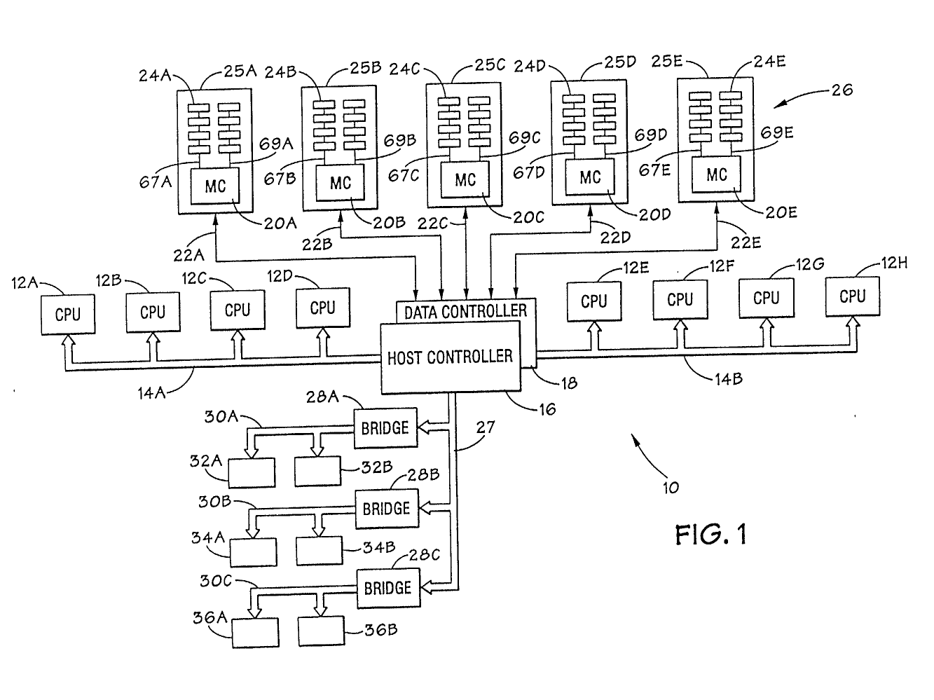

Turning now to the drawings and referring initially to FIG. 1, a block diagram of an exemplary computer system with multiple processor buses and an I/O bus, generally designated as reference numeral 10, is illustrated. The computer system 10 typically includes one or more processors or CPUs. In the exemplary embodiment, the system 10 utilizes eight CPUs 12A-12H. The system 10 utilizes a split-bus configuration in which the CPUs 12A-12D are coupled to a first bus 14A and the CPUs 12E-12H are coupled to a second bus 14B. It should be understood that the processors or CPUs 12A-12H may be of any suitable type, such as a microprocessor available from Intel, AMD, or Motorola, for example. Furthermore, any suitable bus configuration may be coupled to the CPUs 12A-12H, such as a single bus, a split-bus (as illustrated), or individual buses. By way of example, the exemplary system 10 may utilize Intel Pentium III processors and the buses 14A and 14B may operate at 100/133 MHz.

Each of the buses 14A and 14B is coupled to a chip set which includes a host controller 16 and a data controller 18. In this embodiment, the data controller 18 is effectively a data cross-bar slave device controlled by the host controller 16. The data controller 18 may be used to store data from one area of the system 10 awaiting transfer to a requesting area of the system 10. Because of the master/slave relationship between the host controller 16 and the data controller 18, the chips may be referred to together as the host/data controller 16, 18. The host/data controller 16, 18 is further coupled to a main memory 24 via one or more memory controllers. In this particular example, the host/data controller 16, 18 is coupled to five memory controllers 20A-20E via five individual bus sections 22A-22E, respectively. Each of the memory controllers 20A-20E is further coupled to a segment of main memory designated as 24A-24E, respectively. As discussed in detail below, each of the memory segments or modules 24A-24E is typically comprised of dual inline memory modules (DIMMs). Further, each memory module 24A-24E and respective memory controller 20A-20E may comprise a single memory cartridge 25A-25E which may be removable. In the present configuration, data may be stored in a “4+1” parity striping pattern wherein one of the memory cartridges 25A-25E is used to provide redundancy for the collective memory system 26, thereby providing hot plug capabilities for the memory cartridges 25A-25E.

The host/data controller 16, 18 is typically coupled to one or more bridges 28A-28C via an Input/Output (I/O) bus 27. The opposite side of each bridge 28A-28C is coupled to a respective bus 30A-30C, and a plurality of peripheral devices 32A and 32B, 34A and 34B, and 36A and 36B may be coupled to the respective buses 30A, 30B, and 30C. The bridges 28A-28C may be any of a variety of suitable types, such as PCI, PCI-X, EISA, AGP, etc.

Each CPU 12A-12H may include a segment of cache memory for storage of frequently accessed data and programs. Maintaining coherency among the plurality of caches in the CPUs 12A-12H is important to the efficient operation of the system 10. Maintaining coherency among the caches found in each CPU 12A-12H is further complicated by the split-bus configuration since coherency should be maintained between the separate buses 14A and 14B. Also, because requests may originate from or may be directed to not only one of the CPUs 12A-12H, but also from one of the peripheral devices 32A-32B, 34A-34B, or 36A-36B, cache coherency should be maintained along the I/O bus 27, as well.

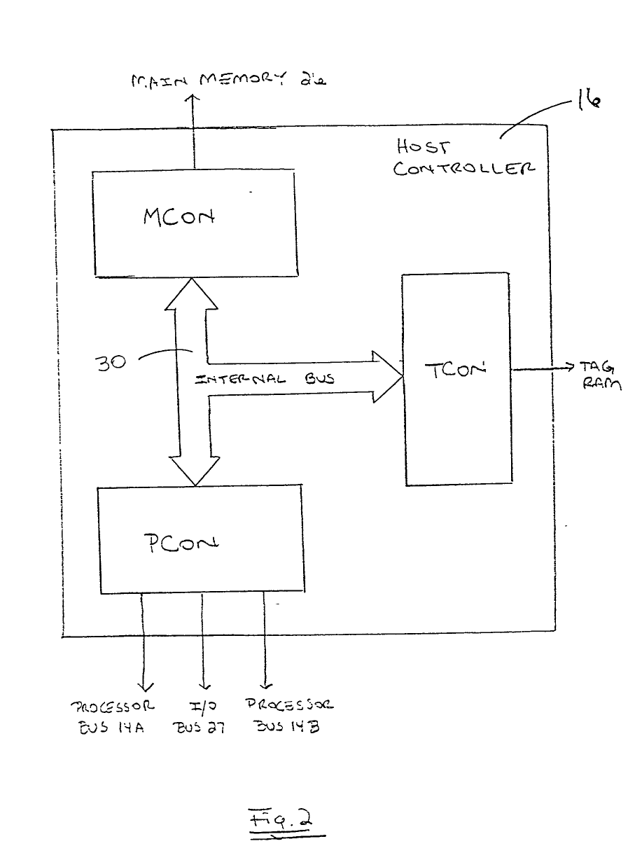

FIG. 2 illustrates a block diagram of the host controller 16. The host controller 16 generally coordinates the exchange of requests and data from the processor buses 14A and 14B, the I/O bus 27, and the memory 26. The host controller 16 includes a master memory controller MCON that facilitates communication with the individual memory controllers 20A-20E in each memory module 25A-25E. The host controller 16 also includes a processor controller PCON for each of the processor and I/O buses 14A, 14B, and 27. For simplicity, the processor controller corresponding to the processor bus 14A is designated as “PCON0.” The processor controller corresponding to the processor bus 14B is designated as “PCON1.” The processor controller corresponding to the I/O bus 27 is designated as “PCON2.” Essentially, each processor controller PCON0-PCON2 serves the same function which is to connect a respective bus which is external to the host controller 16 (i.e., processor bus 14A and 14B and I/O bus 27) to the internal blocks of the host controller 16. Thus, the processor controllers PCON0-PCON2 facilitate the interface from the host controller 16 to each of the buses 14A, 14B, and 27. Further, in an alternate embodiment, a single processor controller PCON may serve as the interface for all of the system buses 14A, 14B, and 27. Any number of specific designs for the processor controller PCON and the memory controller MCON may be implemented in accordance with the bus configurations described herein, as can be understood by those skilled in the art.

The host controller 16 also includes a tag controller TCON. The TCON module maintains coherency and request cycle ordering in the system 10. “Cache coherence” refers to a protocol for managing the caches in a multiprocessor system so that no data is lost or over-written before the data is transferred from the cache to a requesting or target device. Because frequently-accessed data may be stored in the cache memory, the agent requesting data stored in the memory should be able to identify which area of the memory 26 (cache or non-cache) it should access to retrieve the required information as efficiently as possible. A “tag RAM” is an area in the cache that identifies which data from the main memory is currently stored in each cache line. The actual data is stored in a different part of the cache called the data store. The values stored in the tag RAM determine whether the actual data can be retrieved quickly from the cache or whether the requesting device must access the slower DRAM portion of the main memory 26. Thus, the tag controller TCON maintains coherency in cycle ordering and controls access to the tag RAM. Any number of specific designs for a tag controller TCON for maintaining cache coherency may be implemented in accordance with the bus configurations described herein, as can be understood by those skilled in the art.

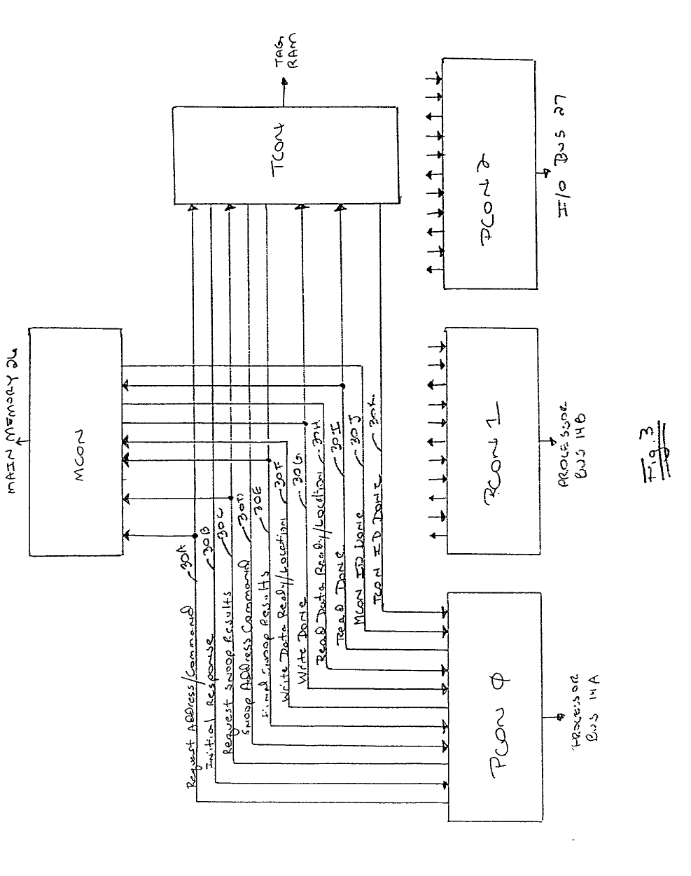

An internal bus 30 generally provides an interface among the various modules in the host controller 16. The present internal bus structure 30 provides a standard internal interface which addresses the problems previously described in the background of the present application. The design of the internal bus structure 30 optimally connects processor buses, I/O buses, the memory controller MCON, and the tag controller TCON (i.e. coherency/ordering interface) by providing a point-to-point, split-transaction, pipelined, multi-phase bus optimized for maximum processor performance and system through put, as will be further discussed with reference to FIG. 3. Further, by standardizing the design of the internal bus structure 30, system design, design re-use, modular testing, and system upgrades can be performed more easily than with unique internal architectural bus designs which are used in traditional host controller-based systems.

The following description introduces specific details in the design of the internal bus structure 30. The forthcoming description discusses multiple design aspects for the internal bus structure 30 which ultimately provide increased system performance. First, general descriptions of design considerations and implementations are provided and may be better understood with general reference to FIG. 3. Next, a specific embodiment of the present internal bus structure 30 design with specific reference to exemplary signal paths, which also may be better understood with specific reference to FIG. 3, is described.

Turning generally to FIG. 3, a more detailed block diagram of the host controller 16 and internal bus structure 30 is illustrated. As can be seen in FIG. 3, the internal bus structure 30 comprises a plurality of buses, such as buses 30A-30K. The buses 30A-30K and associated signals will be discussed more specifically below. For each request or cycle that is delivered to the host controller 16, there are a number of signals and internal responses that are delivered via individual buses 30A-30K in the present system. Thus, for each request there are a series of ordered exchanges among the various modules within the host controller 16. The specific exchanges on each bus 30A-30K associated with each request or cycle are design dependent. However, general techniques discussed below may be implemented to provide a standard design for the internal bus structure 30 in which specific implementations may be achieved.

One aspect of the internal bus structure 30 is that each transaction associated with a particular request is exchanged on a single unidirectional bus 30A-30K. As previously discussed when a request is received by a processor controller PCON, a series of transactions or exchanges among the various components in the system is conducted. Not until the plurality of transactions associated with each request are completed can the request ultimately be retired. Present internal bus structure 30 conducts each transaction or exchange via an associated signal on a separate unidirectional bus 30A-30K. By executing each transaction associated with a request on a separate, individual bus 30A-30K, the routing congestion and design complexity are minimized. Because each bus 30A-30K is unidirectional and since each bus 30A-30K has an associated signal (i.e., each bus 30A-30K has a unique signal associated with it and signals are not shared between buses 30A-30K), certain connections in the system can be eliminated. For instance, the bus 30B in the present embodiment carries an Initial Response signal. As will be further explained below, the Initial Response signal is delivered only from the tag controller TCON to an associated processor controller, here PCON0. Thus, rather than providing a signal path (i.e., an additional bus) to the memory controller MCON, the bus associated with the Initial Response signal, here bus 30B, is only connected between the tag controller TCON and the processor controller PCON0. Thus, a bus connection to the memory controller MCON may be eliminated thereby reducing routing congestion.

Another advantage of the present design is the point-to-point connections of individual buses 30A-30K, each carrying an individual and unique signal associated with a particular request transaction. Functionally, each bus 30A-30K that is coupled to more than one module is illustrated as a tapped line. For example, bus 30A is coupled between the processor controller PCON0 and the tag controller TCON, as well as between processor controller PCON0 and the memory controller MCON. It should be understood that in the present point-to-point configuration, there are two separate buses: one between the processor controller PCON0 and the tag controller TCON, and one between the processor controller PCON0 and the memory controller MCON. In the present protocol that allows point-to-point connections of all signals, layout congestion, which is a particular problem associated with design and layout, is reduced. In designing system configurations, an initial design layout is often facilitated using a particular type of electronic layout software. Generally, the layout software attempts to optimize design layout by centralizing all of the components with multiple accesses. For those modules and components that receive a signal from a line that is also routed to several other components, the layout tool will generally try to centralize the multi-branching signal buses thereby creating design congestion. By providing point-to-point connections for all of the individual buses 30A-30K, electronic design layout is made easier. This is advantageous in floor planning, routing, and timing requirements that arise in deep sub-micron designs which are found in the present system.

Point-to-point connections also facilitate the implementation of another design advantage. By having point-to-point connections, other modules can easily be added to the system. In the particular embodiment illustrated in FIG. 3, three processor controllers PCON0-PCON2 are illustrated. Processor controllers PCON0 and PCON1 correspond with processor buses, while the processor controller PCON2 corresponds with an I/O bus. For a system having point-to-point connections of each signal on the internal bus structure 30, additional processor controllers can easily be added to the system without affecting the existing modules. Further, the removal of a particular module, such as the processor controller associated with the I/O bus (i.e., PCON2), can also be easily facilitated without affecting the rest of the system.

Further, because the present system centralizes coherency control and cycle ordering in a single module, here the tag controller TCON, the point-to-point connections allow for a multiplicity of processor and I/O bus segments to be connected or removed from the system easily without consideration of coherency and cycle ordering. The internal bus structure protocol avoids direct processor-to-processor and processor-to-I/O communication by routing information through central modules which facilitate exchanges with each processor and I/O interface. This allows a variable number of new processor and I/O modules to be connected without having to re-design or alter the existing system modules.

Having a formalized internal bus structure 30 with point-to-point connections allows a highly complex system design to be broken down into smaller, more manageable segments. Each of the smaller segments can then be tested independently, efficiently, and with greater control as compared with verifying the entire system design at the same time. This leads to a faster development and debug time, and it allows each of the smaller design segments to be developed independently. This mitigates overall system design delays based on slow development of individual modules. Each module (MCON, PCON, TCON) can be independently tested because of the single formalized internal bus design and the point-to-point connections associated with the internal bus structure 30. Rather than having to replicate multiple internal buses providing connections among the modules, only a single internal bus structure 30 is replicated to test the individual modules. This is also advantageous if the design for a particular block is complete and awaiting completion of the remaining blocks in the system. The advanced block can be tested and redesigned as necessary before the rest of the blocks in the system are complete.

Another advantage of the present system is the identification (ID) tagging structure. As a processor controller PCON receives a request from an agent on a corresponding bus, the request is tagged by the processor controller PCON such that it includes a unique ID containing source, destination, and cycle information. The source/cycle/destination ID is carried through each transaction of each request. The source ID corresponds to the source of the request (e.g., PCON0-PCON2 or TCON). The destination ID corresponds to the destination of the request (e.g., PCON0-PCON2, MCON, TCON, Config., broadcast). The cycle ID corresponds to a unique ID for each request and may include a READ/WRITE bit to identify the request type and a toggle bit to be discussed further below. By retaining the source/cycle/destination ID through each transaction issued on the individual buses 30A-30K of the internal bus structure 30 for a corresponding request, each transaction can be completed out of order since the particular transactions can be easily tracked. In prior systems, because ID information was not retained for each transaction on a particular request, the transactions had to be executed in a particular sequence so that the system could identify each transaction and associate it with the current request being executed. By allowing for out of order returns of transactions on the buses 30A-30K, system performance can be increased. Further, since source and destination identification data is carried through each transaction for every request, adding other interfaces, such as a fourth processor controller PCON3 (not shown), is simplified. The processor controller PCON3 would have a unique identification to provide source and destination ID for any requests being processed through the processor controller PCON3.

As previously discussed, a toggle bit may be added to the cycle ID to allow an ID to be used after a request is effectively completed, but before each and every transaction for the request has been received. For example, the processor controller PCON may receive a request and initiate the request to the corresponding module such as the memory controller MCON. Once the processor controller PCON initiates the request through the memory controller MCON or the tag controller TCON, the toggle bit can be set and the cycle ID can be reused in the queue by the processor controller PCON since the processor controller PCON has completed its task. However, at this point, the request may not be retired since the other transactions corresponding to the memory controller MCON and the tag controller TCON have not been completed. The processor controller PCON, on the other hand, is finished with its portion of the request. The toggle bit is provided such that it clears a location in the associated queue for another transaction. By toggling the bit, the rest of the system sees the queue location as a new address and can thereby deliver another request to the queue in the processor controller PCON before the original request is retired. This mechanism effectively doubles the number of unique transactions without having to double the size of the request queues.

Another feature of the present system is the minimizing of stalls associated with unnecessary snoop operations. In a snoop based system, such as the present system, the tag controller TCON performs tag RAM look-ups to determine whether the cache memory contains requested data such that it may be retrieved quickly. However, some requests do not require access to the tag RAMs to determine cache coherency. Also, some requests may not be able to get immediate access to the tag RAMs.. In these cases, a snoop response can be determined prior to performing a tag look-up by generating an initial response to minimize the number of snoop stalls that are issued by the processor controller PCON to the requesting agent while awaiting the snoop results from the tag controller TCON. The minimizing of the snoop stalls is achieved by implementing an early initial response. Based on the transaction type, the tag controller TCON immediately sends an early initial response indicating that no tag RAM look-up is necessary. This may minimize or even eliminate the number of stalls that are issued to requesting agents. To utilize this feature, the tag controller TCON is embedded with information relating to transaction types that do not require snoops. An early initial response may be provided for all I/O requests, all memory WRITE requests, and all memory READ requests that are unable to obtain immediate access to the unified coherency queue.

Referring more specifically to FIG. 3, an exemplary request and associated transactions are described. An exemplary embodiment utilizing specific signals and transactions on the buses 30A-30K of the internal bus structure 30 is illustrated. The specific request transactions and buses described herein are exemplary and are used for one particular implementation. However, the techniques discussed above corresponding to the protocol and design techniques for the internal bus structure 30 are applicable to other designs implementing various other signals corresponding to requests. Further, while buses 30A-30K are illustrated and described with specific reference to the processor controller PCON0, similar buses are provided for the remaining modules, such as processor controllers PCON1 and PCON2.

Initially, a request from the processor controller PCON0 is delivered to the memory controller MCON and the tag controller TCON via bus 30A. The Request Address/Command signal is a buffered signal including request information and the corresponding address information. The Request Address/Command signal is embedded with source, cycle destination, and request identification information, as previously discussed, as well as any other system specific information, such as non-cacheable address flags and deferral flags for example. After receiving the Request Address/Command signal from the processor controller PCON0, the tag controller TCON generates an Initial Response signal and delivers it to the processor controller PCON0 via bus 30B. The Initial Response signal is generally encoded with cache content information corresponding to the requested address signal. The processor controller PCON0 sends the acquired snoop results for the identified transaction via a Request Snoop Results signal. The Request Snoop Results signal is delivered to the memory MCON and tag controller TCON via the bus 30C. Next, the tag controller TCON delivers a Snoop Address/Command signal, via bus 30D, to the processor controller PCON0. The Snoop Address/Command signal includes information similar to the Request Address/Command signal. That is, the Snoop Address/Command signal contains information corresponding to the address location of the requested information based on the snoop transaction. Final snoop results are delivered from the tag controller TCON to the memory controller MCON and the processor controller PCON0 via the bus 30E. The WRITE Data Ready/Location signal indicates to the memory controller MCON that the processor controller PCON has queued new data into its input data register. The WRITE Data Ready/Location signal, delivered via bus 30F, includes source, destination, and cycle identification as well as data queue location information to identify the location of the data queue within the data controller 18 wherein the data resides. The WRITE Done signal, which is carried from the memory controller MCON to the tag controller TCON and the processor controller PCON0 via bus 30G, indicates to the processor controller PCON0 that the memory controller MCON has pulled the data out of the input data register in the processor controller PCON0. The READ Data Ready/Location signal, which is carried via bus 30H from the memory controller MCON to the processor controller PCON0, indicates to the processor controller PCON0 that the memory controller MCON has queued data into the data input register. The READ Done signal, which is carried via bus 30I from the processor controller PCON0 to both the memory controller MCON and the tag controller TCON, indicates that the processor controller PCON0 has pulled the data out of the memory controller's MCON data register. The MCON ID Done signal, which is delivered bus 30J, indicates to the processor controller PCON0 that the memory controller MCON is completely finished with the identified transaction. Upon receiving this information, the processor controller PCON0 can reuse the specified ID for new transactions without having a conflict in the memory controller MCON, as previously described. Similarly, the TCON ID Done signal, which is carried via bus 30K, is delivered from the tag controller TCON to the processor controller PCON0. The TCON ID Done signal indicates to the processor controller PCON0 that the tag controller TCON is completely finished with the identified transaction. Upon receiving this information, the processor controller PCON0 can reuse the specified ID for a new transaction without having a conflict in the tag controller TCON.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A system comprising:
a processor;
a main memory operably coupled to the processor;
a cache memory operably coupled to the processor; and
a host controller coupled between the processor and the main memory, the host controller comprising:
a memory controller operably coupled to the main memory;
a processor controller operably coupled to the processor;
a coherency controller operably coupled to the cache memory; and
an internal bus structure configured to couple each of the memory controller, the processor controller and the coherency controller to each other, the internal bus structure comprising a plurality of individual buses, wherein each of the individual buses comprises a unidirectional bus configured to transmit only one signal type.

2. The system, as set forth in claim 1, wherein each of the plurality of individual buses is coupled only between two of the memory controller, the processor controller and the coherency controller.

3. The system, as set forth in claim 2, wherein the plurality of individual buses is coupled between the memory controller and the processor controller.

4. The system, as set forth in claim 2, wherein the plurality of individual buses is coupled between the memory controller and the coherency controller.

5. The system, as set forth in claim 2, wherein the plurality of individual buses is coupled between the processor controller and the coherency controller.

6. The system, as set forth in claim 1, wherein each of the plurality of individual buses is configured to transmit only one respective signal type and wherein each respective signal type corresponds to a single transaction in a request operation.

7. The system, as set forth in claim 6, wherein each respective signal type includes an identification tag.

8. The system, as set forth in claim 7, wherein the identification tag comprises a source identification, a destination identification, and a cycle identification.

9. The system, a set forth in claim 8, wherein the cycle identification comprises a toggle bit configured to free the cycle identification for re-use before each transaction in the request operation is complete.

10. The system, as set forth in claim 1, wherein the processor comprises the cache memory.

11. The system, as set forth in claim 1, comprising:
a plurality of processor buses;
a plurality of processing units, wherein each processing unit is coupled to a respective one of the plurality of processor buses; and
a plurality of processor controllers, each processor controller corresponding to a respective one of the plurality of processor buses, wherein the processor controllers are not directly coupled to each other via the internal bus structure.

12. An internal bus structure comprising a plurality of individual buses, each of the individual buses comprising a unidirectional bus configured to transmit only one signal type.

13. The internal bus structure, as set forth in claim 12, wherein each individual bus is coupled between only a first controller and a second controller.

14. The internal bus structure, as set forth in claim 13, wherein the first controller comprises a processor controller.

15. The internal bus structure, as set forth in claim 13, wherein the second controller comprises one of a memory controller and a coherency controller.

16. The internal bus structure, as set forth in claim 12, wherein each of the individual buses is configured to transmit only one signal type and wherein each signal type corresponds to a single transaction in a request operation.

17. The internal bus structure, as set forth in claim 16, wherein each signal type includes an identification tag.

18. The internal bus structure, as set forth in claim 17, wherein the identification tag comprises a source identification, a destination identification and a cycle identification.

19. The internal bus structure, as set forth in claim 18, wherein the cycle identification includes a toggle bit configured to free the cycle identification for re-use before each transaction in the request operation is complete.
